(19) United States
(12) Patent Application Publication
(10) Pub. No.: US 2021/0191785 A1
(43) Pub. Date: Jun. 24, 2021

(54) VIRTUALIZED COMPUTING ENVIRONMENT CONSTRUCTED BASED ON INFRASTRUCTURE CONSTRAINTS

(71) Applicant: VMware, Inc., Palo Alto, CA (US)

(72) Inventors: Yixing JIA, Beijing (CN); GUANG LU, Beijing (CN); PENGPENG WANG, Beijing (CN); HAOYU LI, Beijing (CN)

(73) Assignee: VMware, Inc., Palo Alto, CA (US)

(21) Appl. No.: 16/788,293

(22) Filed: Feb. 11, 2020

(30) Foreign Application Priority Data
Dec. 24, 2019 (CN) PCT/CN2019/127875

(51) Int. Cl. G06F 9/50; G06F 9/48

(52) U.S. Cl. CPC G06F 9/5077; G06F 2209/505; G06F 2209/506; G06F 9/4856

(57) ABSTRACT

Example methods are provided to perform an operation associated with a first host to manage a virtualized computing environment. One example method includes generating, by the management entity, a first set of infrastructure data metrics of the first host, wherein the first host is supported by infrastructure elements having a set of infrastructure constraints. The method also includes querying the first host to obtain an identification of the first host, associating the first host with the first set of infrastructure data metrics based on the identification, and determining whether a first infrastructure constraint of a first infrastructure element from the set of infrastructure constraints has been reached before performing the operation to manage the virtualized computing environment.

### CROSS-REFERENCE TO RELATED APPLICATION

The present application (Attorney Docket No. E907) claims the benefit of Patent Cooperation Treaty (PCT) Application No. PCT/CN2019/127875, filed Dec. 24, 2019, which is incorporated herein by reference.

### BACKGROUND

Unless otherwise indicated herein, the approaches described in this section are not admitted to be prior art by inclusion in this section.

Virtualization allows the abstraction and pooling of hardware resources to support virtual machines in a virtualized computing environment, such as a Software-Defined Datacenter (SDDC). For example, through server virtualization, virtual machines running different operating systems may be supported by the same physical machine (e.g., referred to as a “host”). Each virtual machine is generally provisioned with virtual resources to run an operating system and applications. Further, through storage virtualization, storage resources of a cluster of hosts may be aggregated to form a single shared pool of storage. The shared pool is accessible by virtual machines supported by the hosts within the cluster.

Generally, hosts are disposed in one or more data centers with certain mechanical, electrical, and optical infrastructure. Some example infrastructure elements include, but not limited to, server rooms with racks to house the hosts, network equipment to provide communication capabilities to the hosts, sensors to detect environment conditions adjacent to the hosts, controllers to control environment conditions adjacent to the hosts, cooling systems to cool the temperature of the server rooms, power distribution units and cables to provide powers, uninterruptible power system, and diesel power generators to provide emergency powers. However, in practice, virtualization usually overlooks constraints associated with these infrastructure elements.

### BRIEF DESCRIPTION OF DRAWINGS

FIG. 1 is a schematic diagram illustrating an example virtualized computing environment that is managed based on the constraints associated with infrastructure elements;

FIG. 2 is a flowchart of an example process for a management entity to manage a virtualized computing environment using an infrastructure constraint module;

FIG. 3 is an example of a first set of infrastructure data metrics of a host;

FIG. 4 is an example of a second set of infrastructure data metrics of another host; and

FIG. 5 is a flowchart of another example process for management entity to manage a virtualized computing environment using an infrastructure constraint module.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

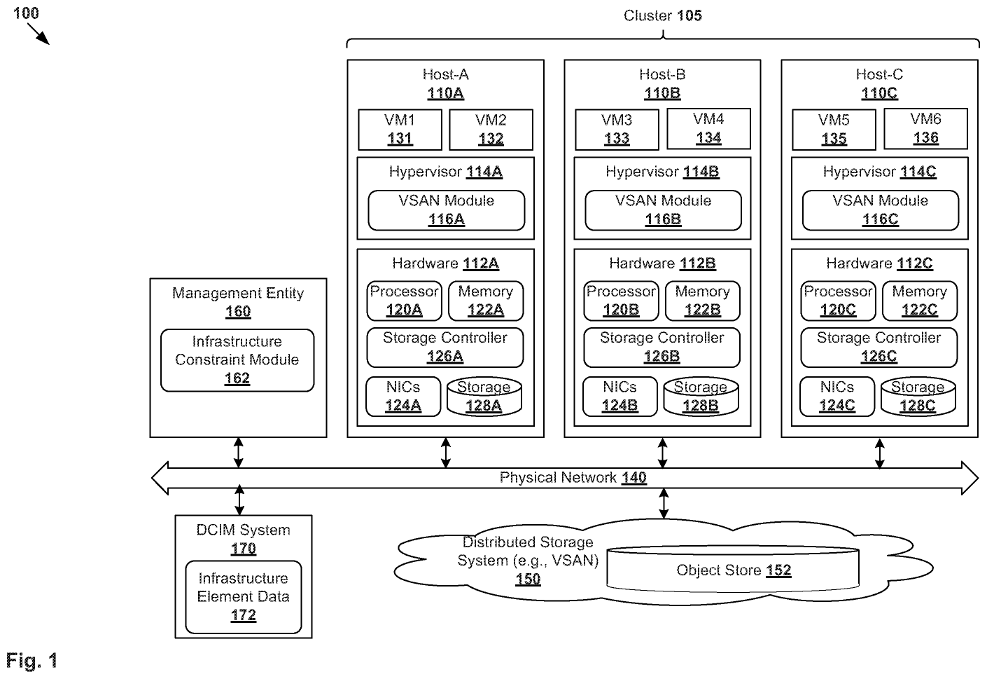

Challenges relating to constructing virtualized computing environments will now be explained in more detail using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes cluster 105 of multiple hosts, such as Host-A 110A, Host-B 110B, and Host-C 110C. In the following, reference numerals with a suffix “A” relates to Host-A 110A, suffix “B” relates to Host-B 110B, and suffix “C” relates to Host-C 110C. Although three hosts (also known as “host computers”, “physical servers”, “server systems”, “host computing systems”, etc.) are shown for simplicity, cluster 105 may include any number of hosts. Although one cluster 105 is shown for simplicity, virtualized computing environment 100 may include any number of clusters.

Each host 110A/110B/110C in cluster 105 includes suitable hardware 112A/112B/112C and executes virtualization software such as hypervisor 114A/114B/114C to maintain a mapping between physical resources and virtual resources assigned to various virtual machines. For example, Host-A 110A supports VM1 131 and VM2 132; Host-B 110B supports VM3 133 and VM4 134; and Host-C 110C supports VM5 135 and VM6 136. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system on host 110A/110B/110C.

Each host 110A/110B/110C in cluster 105 is disposed in one or more data centers supported by infrastructure elements. Some example infrastructure elements include, but not limited to, racks, physical network equipment, temperature and/or humidity sensors, temperature and/or humidity controllers, cooling systems, power distribution units, uninterruptible power system and diesel power generators.

Virtualized computing environment 100 may include a data center infrastructure management (DCIM) system 170. In some embodiments, DCIM system 170 monitors, measures, manages and/or controls utilizations and energy consumptions of IT-related infrastructure elements (e.g., servers, storage and network switches) and facility infrastructure elements (e.g., power distribution units and computer room air conditioners). In some embodiments, DCIM system 170 stores the monitored/measured infrastructure element data 172. Some examples of DCIM system 170 may include, but not limited to, NIyte, PowerIQ, and Device42.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual disk(s), virtual NIC(s), etc.

Storage controller 126A/126B/126C may be any suitable controller, such as redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hosts 110A-110C in cluster 105 aggregate their storage resources 128A-128C to form distributed storage system 150, which represents a shared pool of storage resources. For example in FIG. 1, Host-A 110A, Host-B 110B and Host-C 110C aggregate respective local physical storage resources 128A, 128B and 128C into object store 152 (also known as a datastore or a collection of datastores). In this case, data (e.g., virtual machine data) stored on object store 152 may be placed on, and accessed from, one or more of storage resources 128A-128C. In practice, distributed storage system 150 may employ any suitable technology, such as Virtual Storage Area Network (VSAN) from VMware, Inc. Cluster 105 may be referred to as a VSAN cluster.

In virtualized computing environment 100, management entity 160 provides management functionalities to various managed objects, such as cluster 105, hosts 110A-110C, virtual machines 131-136, etc. Conventionally, in response to receiving a service request, management entity 160 is configured to manage virtualized computing environment 100 to fulfill the service request. More specifically, management entity 160 is configured to perform one or more operations associated with one or more hosts 110A-110C of cluster 105 based on the available resources of hosts 110A-110C. Such conventional approaches do not consider the constraints associated with the infrastructure elements that support hosts 110A-110C and have various shortcomings. Specifically, failing to consider the constraints associated with the infrastructure elements is likely to lead to failures in fulfilling the service request. For example, a cluster having all of its hosts connected to one single power distribution unit may stop functioning when the power distribution unit crashes. In another example, operations associated with backing up a first cluster to a second cluster may fail if the first cluster and the second cluster share the same power distribution unit or the same network switch and either the power distribution unit or the network switch fails.

According to embodiments of the present disclosure, management entity 160 is configured to perform one or more operations associated with one or more hosts 110A-110C to manage virtualized computing environment 100 based on infrastructure constraint module 162. In some embodiments, infrastructure constraint module 162 obtains infrastructure element data 172 from DCIM system 170.

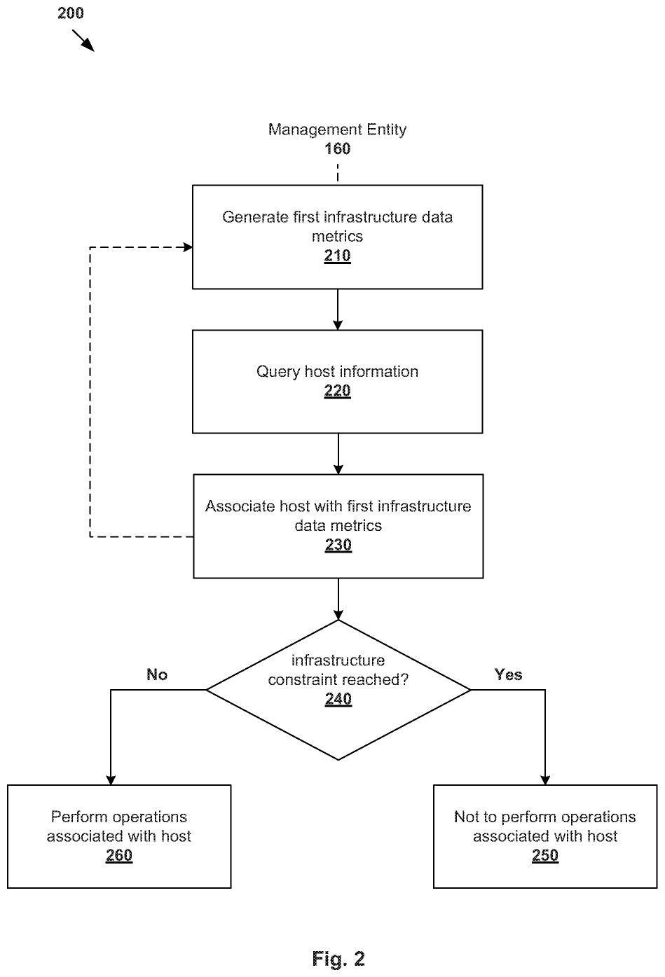

In more detail, FIG. 2 is a flowchart of example process 200 for management entity 160 to manage virtualized computing environment 100 using infrastructure constraint module 162. Example process 200 may include one or more operations, functions, or actions illustrated by one or more blocks, such as 210 to 260. The various blocks may be combined into fewer blocks, divided into additional blocks, and/or eliminated depending on the desired implementation. Example process 200 may be performed by management entity 160, such as using infrastructure constraint module 162, etc. Management entity 160 may be implemented by one or more physical and/or virtual entities.

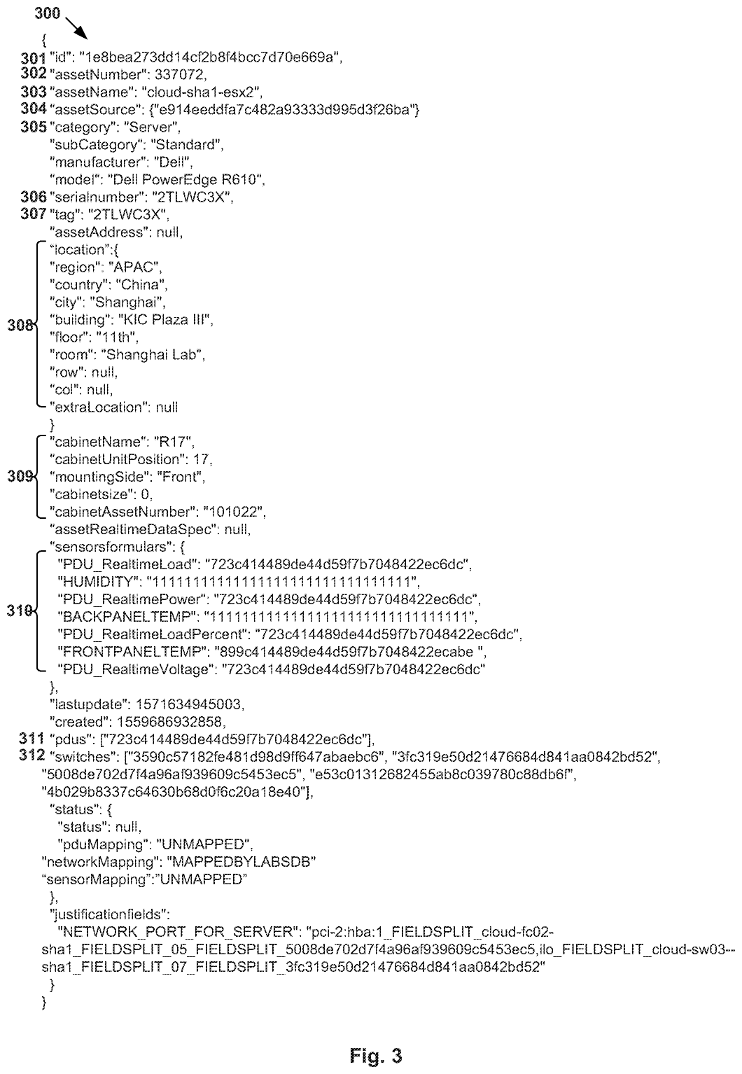

At block 210 in FIG. 2, infrastructure constraint module 162 is configured to generate a set of infrastructure data metrics of an asset in a data center. In some embodiments, an asset may be an infrastructure element, such as a host, a power distribution unit, a network switch, and a sensor. In some embodiments, FIG. 3 illustrates an example first set of infrastructure data metrics 300 of a first host.

The first set of infrastructure data metrics 300 may include, but not limited to, id 301 as an object identification, asset number 302 as an unique number that can identify the asset in a DCIM system, asset name 303 as the name of the asset in the DCIM system, asset source 304 which identifies a source of the DCIM system, category 305 which identifies a category of the asset, serial number 306 which identifies a serial number of the asset which can be used to identify the asset, tag 307 which identifies the asset in some DCIM management systems, location information 308 which identifies a physical location of the asset, cabinet information 309 which identifies the cabinet where the asset is located and oriented, sensor information 310 which includes detected real time load of a power distribution unit connected to the asset, detected humidity around the asset, detected real time power level of the power distribution unit connected to the asset, detected temperatures of a back panel and a front panel of the asset, and detected real time voltage of the power distribution unit connected to the asset, power distribution unit in use (“pdus”) 311 which identifies one or more object identifications of power distribution units connected to the asset, and switches 312 which identify one or more object identifications of network switches connected to the asset. In some embodiments, the first set of infrastructure data metrics 300 may be generated based on the data stored in the DCIM management system.

At block 220 in FIG. 2, infrastructure constraint module 162 is configured to query a first host for information associated with the first host. In some embodiments, the information includes, but not limited to, a serial number of the first host and/or a tag of the first host.

At block 230 in FIG. 2, infrastructure constraint module 162 is configured to associate the queried first host with the first set of infrastructure data metrics based on the queried information. In some embodiments, in response to the queried serial number or tag of the first host to be 2TLWC3X, infrastructure constraint module 162 is configured to associate the first host with the first set of infrastructure data metrics 300, because the asset in the first set of infrastructure data metrics 300 also has a serial number or tag of 2TLWC3X. Accordingly, the first host has location information 308, cabinet information 309, sensor information 310, connects to power distribution units 311 (i.e., 723c414489de44d59f7b7048422ec6dc), and network switches 312 (i.e., 3590c57182fe481d98d9ff647abaebc6, 3fc319e50d21476684d841aa0842bd52, 5008de702d7f4a96af939609c5453ec5, and e53c01312682455ab8c039780c88db6f, 4b02968337c64630b68d0f6c20a18e40).

In some embodiments, the processing at block 230 may be looped back to block 210. Infrastructure constraint module 162 is configured to generate a new set of infrastructure data metrics 300′ of the same asset. In some embodiments, the new set of infrastructure data metrics 300′ may have the same information corresponding to 301, 302, 303, 304, 305, 306 and 307 of the first set of infrastructure data metrics 300, because they refer to the same asset(s). However, the new set of infrastructure data metrics 300′ may have updated location information 308′, updated cabinet information 309′, updated sensor information 310′, updated pdus 311′ and updated switches 312′, because 308′, 309′, 310′, 311′ and 312′ may change for the first host from time to time. In some embodiments, both updated information (e.g., 308′, 309′, 310′, 311′ and 312′) and original information (e.g., 308, 309, 310, 311 and 312) are saved in the new set of infrastructure data metrics 300′.

In some embodiments, block 230 may be followed by block 240. At block 240 in FIG. 2, infrastructure constraint module 162 is configured to determine whether one or more constraints associated with the infrastructure elements are reached. Example constraints associated with the infrastructure elements will be further described below.

At 250 in FIG. 2, in response to a determination made by infrastructure constraint module 162 that one or more constraints associated with the infrastructure elements supporting the first host have been reached, infrastructure constraint module 162 is configured not to perform certain operations associated with the first host. For example, infrastructure constraint module 162 may reject the first host from being included or added in the cluster. In another example, infrastructure constraint module 162 may issue commands to other hosts in the cluster not to migrate virtual machines to the first host.

At 260 in FIG. 2, in response to a determination made by infrastructure constraint module 162 that one or more constraints associated with the infrastructure elements supporting the first host have not been reached, infrastructure constraint module 162 is configured to perform certain operations associated with the first host. For example, infrastructure constraint module 162 may keep or add the first host in the cluster. In another example, infrastructure constraint module 162 may issue commands to other hosts in the cluster to migrate virtual machines to the first host.

Constraint Associated with Power Distribution Unit in Clustering Host (First Scenario)

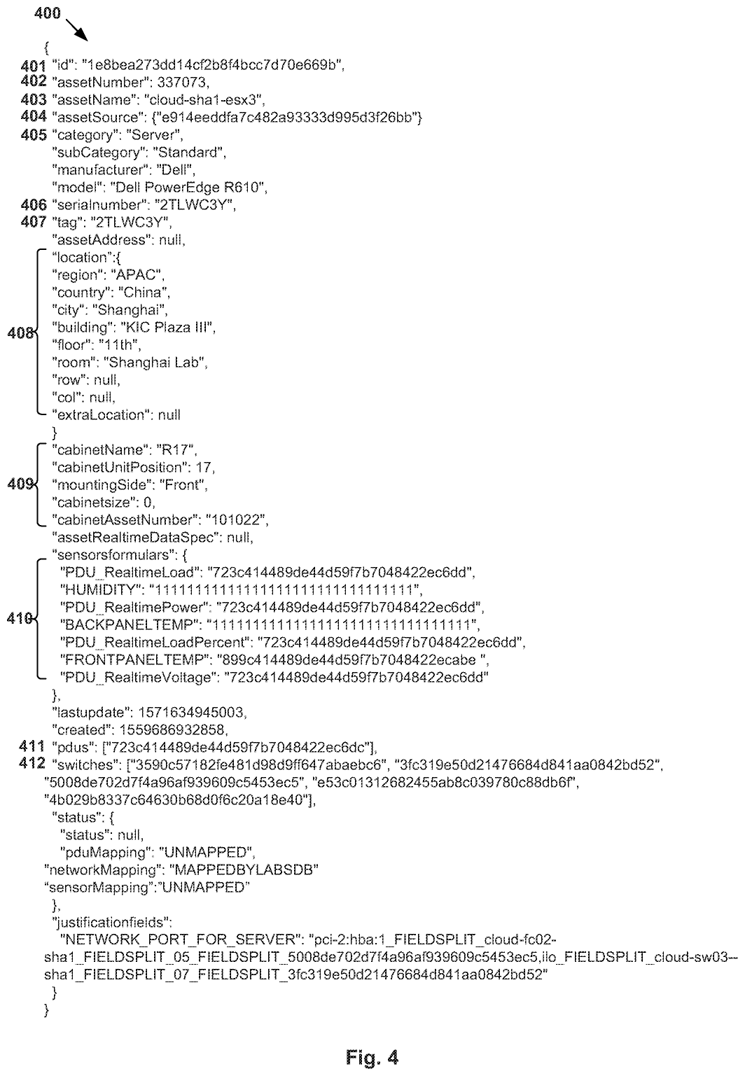

FIG. 4 illustrates an example second set of infrastructure data metrics 400 of a second host. The second set of infrastructure data metrics 400 may include, but not limited to, id 401 as an object identification, asset number 402 as an unique number that can identify the second host in a DCIM system, asset name 403 as the name of the second host in the DCIM system, asset source 404 which identifies a source of the DCIM system, category 405 which identifies a category of the second host, serial number 406 which identifies a serial number of the second host which can be used to identify the second host, tag 407 which may be used to identify the second host in some DCIM systems, location information 408 which identifies a physical location of the second host, cabinet information 409 which identifies the cabinet where the second host is located and oriented, sensor information 410 which includes detected real time load of a power distribution unit connected to the second host, detected humidity around the second host, detected real time power level of the power distribution unit connected to the second host, detected temperatures of a back panel and a front panel of the second host, and detected real time voltage of the power distribution unit connected to the second host, pdus 411 which identifies one or more object identifications of power distribution units connected to the second host and switches 412 which identify one or more object identifications of network switches connected to the second host. In some embodiments, the second set of infrastructure data metrics 400 may be generated based on the data stored in the DCIM system.

Assuming the first host having the first set of infrastructure data metrics 300 has formed a cluster, in conjunction with FIG. 1, in response to a service request, management entity 160 is configured to perform operations associated with the second host.

In conjunction with FIG. 1 and FIG. 2, blocks 210, 220 and 230 are performed for the second host by management entity 160. At block 240, infrastructure constraint module 162 is configured to determine whether one or more constraints associated with the infrastructure elements supporting the second host have been reached. In some embodiments, infrastructure constraint module 162 is configured to examine the second set of infrastructure data metrics 400 of the second host and identify that the second host connects to a power distribution unit with an object identification of “723c414489de44d59f7b7048422ec6dc.”

Based on the previously generated and associated first set of infrastructure data metrics 300, infrastructure constraint module 162 is also configured to identify the power distribution unit that the first host is connected to. In response to the first host and the second host both connecting to the same power distribution element with object identification of “723c414489de44d59f7b7048422ec6dc,” in this scenario, infrastructure constraint module 162 determines that a constraint associated with the power distribution unit connected to the first and the second hosts in the cluster has been reached. Accordingly, infrastructure constraint module 162 then issue commands not to perform operations associated with the second host.

Constraint Associated with Network Switches in Clustering Host (Second Scenario)

Assuming the first host having the first set of infrastructure data metrics 300 has formed a cluster, in conjunction with FIG. 1, in response to a service request, management entity 160 is configured to perform operations associated with the second host.

In conjunction with FIG. 1 and FIG. 2, management entity 160 performs blocks 210 to 230 for the second host to associate the second host with the second set of infrastructure data metrics 400. At block 240, infrastructure constraint module 162 is configured to determine whether one or more constraints associated with infrastructure elements supporting the second host are reached. In some embodiments, infrastructure constraint module 162 is configured to examine the second set of infrastructure data metrics 400 of the second host and identify that the second host connects to network switches with object identifications of “3590c57182fe481d98d9ff647abaebc6”, “3fc319e50d21476684d841aa0842bd52”, “5008de702d7f4a96af939609c5453ec5”, “e53c01312682455ab8c039780c88db6f.” Infrastructure constraint module 162 is also configured to identify the network switches that the first host is connected to based on the previously generated and associated first set of infrastructure data metrics 300. Accordingly, infrastructure constraint module 162 identifies that the first host also connects to network switches with object identifications of “3590c57182fe481d98d9ff647abaebc6”, “3fc319e50d21476684d841aa0842bd52”, “5008de702d7f4a96af939609c5453ec5”, “e53c01312682455ab8c039780c88db6f.”

In response to the first host and the second host both connect to the same network switches, in this scenario, infrastructure constraint module 162 determines a constraint associated with the network switches connected to the first and the second hosts is reached, infrastructure constraint module 162 then issue commands not to perform operations associated with the second host.

Constraint Associated with Location in Clustering Host (Third Scenario)

Assuming the first host having the first set of infrastructure data metrics 300 has formed a cluster, in conjunction with FIG. 1, in response to a service request, management entity 160 is configured to add the second host in the cluster to fulfill the request.

In conjunction with FIG. 1 and FIG. 2, management entity 160 is configured to perform blocks 210, 220 and 230. At block 240, infrastructure constraint module 162 is configured to determine whether one or more constraints associated with infrastructure elements supporting the second host are reached. In some embodiments, infrastructure constraint module 162 is configured to examine the second set of infrastructure data metrics 400 of the second host and identify that a physical location of the second host based on 408 and 409. Based on the previously generated and associated first set of infrastructure data metrics 300, infrastructure constraint module 162 is also configured to identify the physical location of the first host from 308 and 309.

In some embodiments, infrastructure constraint module 162 determines that the first host and the second host are in the same room (i.e., Shanghai Lab) and on the same cabinet (i.e., R17; 17). However, to minimize risks, hosts of the same cluster are preferably disposed at different rooms and in different cabinets. In this scenario, infrastructure constraint module 162 determines a constraint associated with rooms/cabinets of the first and the second hosts is reached, infrastructure constraint module 162 then issue commands not to perform operations associated with the second host.

In some embodiments, prior performing operations associated with the second host, infrastructure constraint module 162 is configured to consider whether an infrastructure constraint is reached under the first scenario, the second scenario and/or the third scenario as set forth above.

Constraint Associated with Power Distribution Unit in Clustering Host and Migration (Fourth Scenario)

Assuming the first host having the first set of infrastructure data metrics 300 has formed a cluster, in conjunction with FIG. 1, in response to a service request, management entity 160 is configured to perform operations associated with the second host to fulfill the request.

In conjunction with FIG. 1 and FIG. 2, blocks 210, 220 and 230 are performed for the second host by management entity 160. At block 240, infrastructure constraint module 162 is configured to determine whether one or more constraints associated with infrastructure elements supporting the second host are reached. In some embodiments, infrastructure constraint module 162 is configured to examine the second set of infrastructure data metrics 400 of the second host and determine whether the second host is healthy based on sensor information 410. In some embodiments, sensor information 410 may include, but not limited to, status parameters of the power distribution unit connected to the second host (e.g., PDU_RealtimeLoad, PDU_RealtimePower, PDU_RealtimeLoadPercent and PDU_RealtimeVoltage) and humidity and temperatures adjacent to the second host (e.g., HUMIDITY, BACKPANELTEMP and FRONTPANELTEMP). In some embodiments, infrastructure constraint module 162 is configured to analyze sensor information 410 and determine the power distribution unit (i.e., 723c414489de44d59f7b7048422ec6dc) connected to the second host is to-be-failed, which makes the second host unstable. Therefore, infrastructure constraint module 162 is configured to determine a constraint associated with the power distribution unit is reached and issue commands not to perform operations associated with the second host at 250 in FIG. 2.

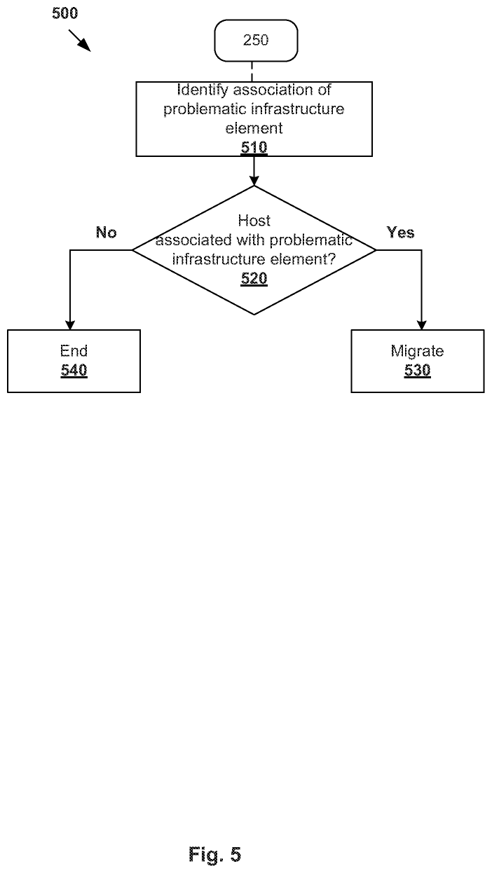

FIG. 5 is a flowchart of example process 500 for management entity 160 to manage virtualized computing environment 100 using infrastructure constraint module 162. Example process 500 may include one or more operations, functions, or actions illustrated by one or more blocks, such as 510 to 540. The various blocks may be combined into fewer blocks, divided into additional blocks, and/or eliminated depending on the desired implementation. Example process 500 may be performed by management entity 160, such as using infrastructure constraint module 162, etc. Example process 500 may be performed after 250 in FIG. 2.

At block 510 in FIG. 5, infrastructure constraint module 162 identifies whether a problematic infrastructure element, such as the power distribution unit having object identification of 723c414489de44d59f7b7048422ec6dc, which may be failing, may about to fail, or may have already failed, is associated with another host. In some embodiments, such associations may be obtained based on previously generated set of infrastructure data metrics of the another host. As set forth above, infrastructure constraint module 162 has generated the first set of infrastructure data metrics 300 and has associated with the first host the first set of infrastructure data metrics 300. Accordingly, infrastructure constraint module 162 may check the first set of infrastructure data metrics 300 for object identification of 723c414489de44d59f7b7048422ec6dc at 510 in FIG. 5.

At block 520 in FIG. 5, infrastructure constraint module 162 is configured to determine whether a host is associated with the problematic power distribution unit. In some embodiments, infrastructure constraint module 162 is configured to determine whether the object identification of 723c414489de44d59f7b7048422ec6dc is in the first set of infrastructure data metrics 300. In response to determining that the object identification of 723c414489de44d59f7b7048422ec6dc is in the first set of infrastructure data metrics 300, process 500 may be followed by block 530. Otherwise, process 500 may be followed by block 540.

At block 530 in FIG. 5, infrastructure constraint module 162 is configured to determine that the first host is unstable because the first host is connected to the problematic power distribution unit. Accordingly, infrastructure constraint module 162 is configured to migrate computations (e.g., migrate virtual machines) on the first host to the other hosts that are not connected to the problematic power distribution unit.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software, firmware, and/or program code with executable instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

It will be understood that although the terms “first,” “second,” third” and so forth are used herein to describe various elements, these elements should not be limited by these terms. These terms are only used to distinguish one element from another. For example, within the scope of the present disclosure, a first element may be referred to as a second element, and similarly a second element may be referred to as a first element. As used herein, the term “and/or” includes any and all combinations of one or more of the associated listed items.

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a management entity to perform an operation associated with a first host to manage a virtualized computing environment, wherein the method comprises:
generating, by the management entity, a first set of infrastructure data metrics of the first host, wherein the first host is supported by infrastructure elements having a set of infrastructure constraints;
querying the first host to obtain an identification of the first host;
associating the first host with the first set of infrastructure data metrics based on the identification; and
determining whether a first infrastructure constraint of a first infrastructure element from the set of infrastructure constraints has been reached before performing the operation to manage the virtualized computing environment.

2. The method of claim 1, further comprising, in response to determining that the first infrastructure constraint has been reached, performing the operation to reject the first host from being included in a cluster.

3. The method of claim 1, further comprising, in response to determining that the first infrastructure constraint has not been reached, performing the operation to add the first host in a cluster.

4. The method of claim 1, wherein the infrastructure elements include at least one of a power distribution unit connected to the first host, a network switch connected to the first host, a cabinet which supports the first host, a sensor to detect environment condition adjacent to the host, and a controller to control environment condition adjacent to the host or a combination thereof.

5. The method of claim 2, further comprising:
after performing the operation to reject the first host from being included in the cluster, identifying an association between the first infrastructure element and a second host based on a second set of infrastructure data metrics of the second host.

6. The method of claim 5, wherein the second set of infrastructure data metrics is generated by the management entity prior to the first set of infrastructure data metrics.

7. The method of claim 5, further comprising, in response that the association between the first infrastructure element and the second host is identified, migrating computations on the second host to another host.

8. A non-transitory computer-readable storage medium that includes a set of instructions which, in response to execution by a processor of a management entity, cause the processor to perform a method to perform an operation associated with a first host to manage a virtualized computing environment, wherein the method comprises:
generating, by the management entity, a first set of infrastructure data metrics of a first host, wherein the first host is supported by infrastructure elements having a set of infrastructure constraints;
querying the first host to obtain an identification of the first host;
associating the first host with the first set of infrastructure data metrics based on the identification; and
determining whether a first infrastructure constraint of a first infrastructure element from the set of infrastructure constraints has been reached before performing the operation to manage the virtualized computing environment.

9. The non-transitory computer-readable storage medium of claim 8, wherein the method further comprises:
in response to determining that the first infrastructure constraint has been reached, performing the operation to reject the first host from being included in a cluster.

10. The non-transitory computer-readable storage medium of claim 8, wherein the method further comprises:
in response to determining that the first infrastructure constraint has not been reached, performing the operation to add the first host in a cluster.

11. The non-transitory computer-readable storage medium of claim 9, wherein the method further comprises:
after performing the operation to reject the first host from being included in the cluster, identifying an association between the first infrastructure element and a second host based on a second set of infrastructure data metrics of the second host.

12. The non-transitory computer-readable storage medium of claim 11, wherein the second set of infrastructure data metrics is generated by the management entity prior to the first set of infrastructure data metrics.

13. The non-transitory computer-readable storage medium of claim 11, wherein the method further comprises:
in response that the association between the first infrastructure element and the second host is identified, migrating computations on the second host to another host.

14. A management entity to perform an operation associated with a first host to manage a virtualized computing environment, comprising:
a processor; and
a non-transitory computer-readable medium having stored thereon program code that, upon being executed by the processor, causes the processor to:
generate, by the management entity, a first set of infrastructure data metrics of the first host, wherein the first host is supported by infrastructure elements having a set of infrastructure constraints;
query the first host to obtain an identification of the first host;
associate the first host with the first set of infrastructure data metrics based on the identification; and
determine whether a first infrastructure constraint of a first infrastructure element from the set of infrastructure constraints has been reached before performing the operation to manage the virtualized computing environment.

15. The computing system of claim 14, wherein the program code that, upon being executed by the processor, causes the processor further to:
in response to determining that the first infrastructure constraint has been reached, perform the operation to reject the first host from being included in a cluster.

16. The computing system of claim 14, wherein the program code that, upon being executed by the processor, causes the processor further to:
in response to determining that the first infrastructure constraint has not been reached, perform the operation to add the first host in a cluster.

17. The computing system of claim 15, wherein the program code that, upon being executed by the processor, causes the processor further to:
after performing the operation to reject the first host from being included in the cluster, identify an association between the first infrastructure element and a second host based on a second set of infrastructure data metrics of the second host.

18. The computing system of claim 17, wherein the program code that, upon being executed by the processor, causes the processor further to generate the second set of infrastructure data metrics prior to the first set of infrastructure data metrics.

19. The computing system of claim 17, wherein the program code that, upon being executed by the processor, causes the processor further to:
in response that the association between the first infrastructure element and the second host is identified, migrate computations on the second host to another host.
